(19) United States
(12) Patent Application Publication
(10) Pub. No.: US 2015/0139293 A1
(43) Pub. Date: May 21, 2015

(54) HIERARCHICAL MODULATION FOR MULTIPLE STREAMS

(71) Applicant: WI-LAN Labs, Inc., San Diego, CA (US)

(72) Inventors: Kenneth L. Stanwood, Vista, CA (US); David Gell, San Diego, CA (US); Murat Karsi, San Diego, CA (US)

(21) Appl. No.: 14/503,308

(22) Filed: Sep. 30, 2014

Related U.S. Application Data
(60) Provisional application No. 61/905,815, filed on Nov. 18, 2013.

(51) Int. Cl. H04L 27/20; H04L 27/01; H04L 27/22; H04L 27/04; H04L 27/06

(52) U.S. Cl. CPC H04L 27/20; H04L 27/04; H04L 27/06; H04L 27/22; H04L 27/01
USPC 375/230; 375/259

(57) ABSTRACT

A receiving device is provided to coordinate transmissions from a first transmitting device and from a second transmitting device of a plurality of transmitting devices to the receiving device in a communication network. The transmissions are coordinated by sending, from the receiving device, a first instruction to the first transmitting device to transmit a first signal according to first transmission characteristics, wherein the first signal comprises a base layer data stream, sending, from the receiving device, a second instruction to the second transmitting device to transmit a second signal according to second transmission characteristics, wherein the second signal comprises an enhanced layer data stream, receiving, at the receiving device, a hierarchical modulation signal comprising the first signal and the second signal being simultaneously transmitted, and separating, at the receiving device, the base layer data stream and the enhanced layer data stream from the received hierarchical modulation signal.

### CROSS-REFERENCE TO RELATED APPLICATION

The present application also claims priority to U.S. Provisional Patent Application No. 61/905,815, filed on Nov. 18, 2013, and entitled “Hierarchical Modulation for Multiple Transmitter Streams,” the entire disclosure of which is incorporated by reference herein.

### BACKGROUND OF THE INVENTION

1. Field of Invention

The present invention relates to telecommunications and more particularly, to a hierarchical modulation technique for transmitting multiple data streams, each from a different transmitter.

2. Description of Related Art

Hierarchical modulation, also called layered modulation, is a signal processing technique for multiplexing and modulating multiple data streams into one single symbol stream. The idea is that one stream (i.e., the base-layer, also called the High Priority stream, HP) is modulated with a robust modulation technique and one or more other streams (i.e., enhancement-layers, also called Low Priority streams, LP) are synchronously superimposed on the base layer with a less robust modulation. Of course, it should be appreciated that the terms “base layer” and “enhanced layer” are used for convenience and that other terms may be used for the different modulated streams without departing from the general concept described above. Hierarchical modulation is a form of superposition pre-coding. When hierarchical modulation signals are transmitted, users with good reception and with hierarchical modulation enabled receivers can demodulate the base and enhancement layers, while users with poor reception or conventional receivers can demodulate only the base layer (the HP stream). Hierarchical modulation has been used in, among other things, video broadcasting such as digital video broadcasting-terrestrial (DVB-T), digital video broadcasting-handheld (DVB-H), and MediaFLO by Qualcomm Incorporated, the implementation of which are readily apparent to one of ordinary skill in the art.

FIG. 1 illustrates a known video broadcasting system 100 for utilizing hierarchical modulation. The base layer is associated with a first data stream from a transmitting device (e.g., base station 110), which is transmitted with a first modulation. In addition, an enhanced layer, which carries a second data stream from the transmitting device (e.g., base station 110), is transmitted using a second modulation on the same time and frequency resources. Note that the first and second modulations may be the same or different modulations. Receiving devices with good channel conditions, e.g., user equipment 120, can receive the combined signal as a signal of higher order modulation. Receiving devices without good channel conditions, e.g., user equipment 130, can only successfully demodulate the base layer of the received combined signal.

FIG. 2 illustrates a constellation diagram of a basic implementation of hierarchical modulation. Here, the base layer is modulated in quadrature phase shift keying (QPSK) (represented by the gray dots), while the enhanced layer is modulated by quadrature amplitude modulation QAM16 (represented by the 16 4-bit constellation points, i.e., transmission symbols, in each quadrant). Demodulating the base layer requires only determining which quadrant the symbol resides in, and the enhanced layer determines the position within the quadrant.

One of the main challenges with hierarchical modulation is the introduction of inter-layer interference (ILI) due to the reduction of the noise margin of the base layer by the introduction of the enhanced layer(s). The noise margin in transmitting the base layer only is a function of the distance between the gray dots in FIG. 2. The addition of the enhanced layer reduces the noise margin of the base layer in some cases due to the reduced distance between the enhanced layer constellation points bordering adjacent quadrants in the figure, which results in a higher bit error rate (BER) for the base layer receivers and affects the overall throughput of the system.

### SUMMARY OF THE INVENTION

In an aspect, a receiving device is provided to coordinate transmissions from a first transmitting device and from a second transmitting device of a plurality of transmitting devices to the receiving device in a communication network. The transmissions are coordinated by sending, from the receiving device, a first instruction to the first transmitting device to transmit a first signal according to first transmission characteristics, wherein the first signal comprises a base layer data stream, sending, from the receiving device, a second instruction to the second transmitting device to transmit a second signal according to second transmission characteristics, wherein the second signal comprises an enhanced layer data stream, receiving, at the receiving device, a hierarchical modulation signal comprising the first signal and the second signal being simultaneously transmitted, and separating, at the receiving device, the base layer data stream and the enhanced layer data stream from the received hierarchical modulation signal.

In another aspect, a method is provided in a first transmitting device within a communication network for coordinating a transmission of a first signal from the first transmitting device to a receiving device with a transmission of a second signal from a second transmitting device to the receiving device. The method includes receiving, at the first transmitting device, transmission information associated with transmission of the first signal, wherein the first signal comprises a base layer data stream or an enhanced layer data stream, and transmitting, from the first transmitting device, the first signal according to the received transmission information, wherein the first signal is transmitted simultaneously with the second signal from the second transmitting device, the first signal and the second signal together forming a hierarchical modulation signal.

The foregoing, and other features and advantages of the invention, will be apparent from the following, more particular description of the preferred aspects of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 illustrates a known video broadcasting system utilizing hierarchical modulation;

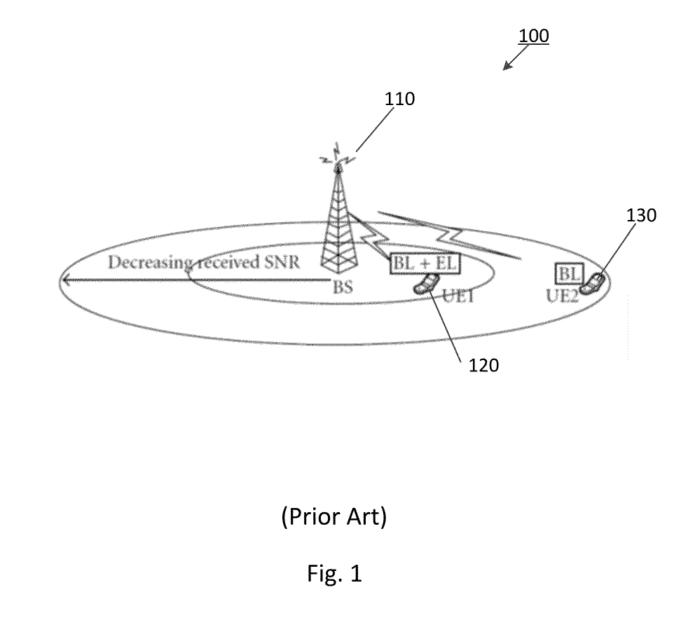

FIG. 2 illustrates a constellation diagram of QPSK/QAM16 hierarchical modulation;

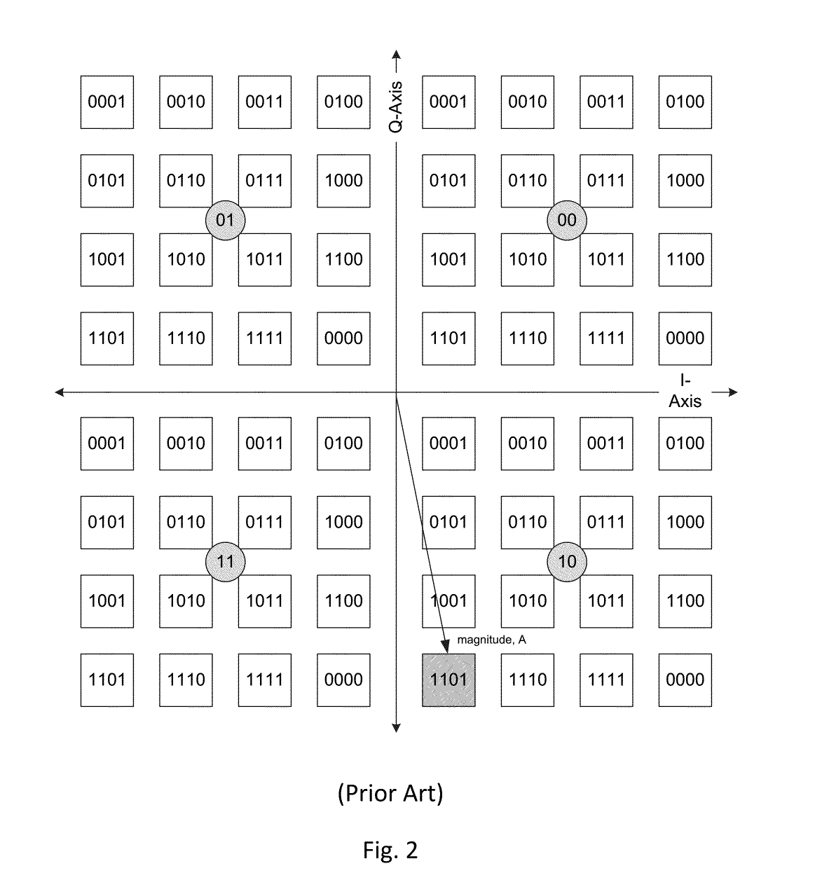

FIG. 3 illustrates a communication network in which with aspects of the invention may be implemented;

FIG. 4 illustrates an access node in accordance with aspects of the invention;

FIG. 5 illustrates a terminal node in accordance with aspects of the invention;

FIG. 6 illustrates an exemplary communication system that includes the access node of FIG. 4 and the terminal node of FIG. 5;

FIG. 7 illustrates a base station receiver according to aspects of the invention;

FIG. 8 illustrates a modulation scheme for multiple streams from multiple transmitters (UE_{A} and UE_{B}) according to aspects of the invention;

FIG. 9 illustrates a modulation scheme for multiple streams from multiple transmitters (UE_{A} and UE_{B}) according to aspects of the invention;

FIG. 10 illustrates a modulation scheme utilizing Gray coding for multiple streams from multiple transmitters according to aspects of the invention;

FIG. 11 illustrates a UE transmitter according to aspects of the invention;

FIG. 12 illustrates a UE transmitter according to aspects of the invention;

FIG. 13 illustrates a modulation scheme for multiple streams from multiple transmitters according to aspects of the invention; and

FIG. 14 illustrates a method to command the uplink transmissions of two UEs in a multi-transmitter hierarchical modulation scheme according to aspects of the invention.

### DETAILED DESCRIPTION

Aspects of the present invention and their advantages may be understood by referring to the figures, wherein like reference numerals refer to like elements. The descriptions and features disclosed herein can be applied to various communication systems, including wireline and wireless networks. For example, the aspects disclosed herein can be used with Cellular 2G, 3G, 4G (including LTE, LTE Advanced, and IEEE 802.16 wireless-network standards referred to as “WiMAX”), cellular backhaul, IEEE 802.11 wireless local access network standards (“Wi-Fi”), Ultra Mobile Broadband (UMB), cable modem, and other point-to-point or point-to-multipoint wireline or wireless technologies. For concise exposition, various aspects are described using terminology and organization of particular technologies and standards. However, the features described herein are broadly applicable to other technologies and standards.

The present invention provides a hierarchical modulation technique for multiple data streams, wherein each data stream is transmitted from a different transmitter. In an exemplary aspect of the invention, stream A is transmitted by device A (UE_{A}) and stream B is transmitted by device B (UE_{B}). Streams A and B are received simultaneously at a receiving device, e.g., a base station (such as an Evolved Node B (eNodeB or eNB) in LTE). This is the case, for instance, if devices A and B are UEs and the receiving device is a base station or ENodeB. Other device/system arrangements, the identification and implementation of which are apparent to one of ordinary skill in the art, are possible for implementing the present hierarchical modulation technique for multiple data streams.

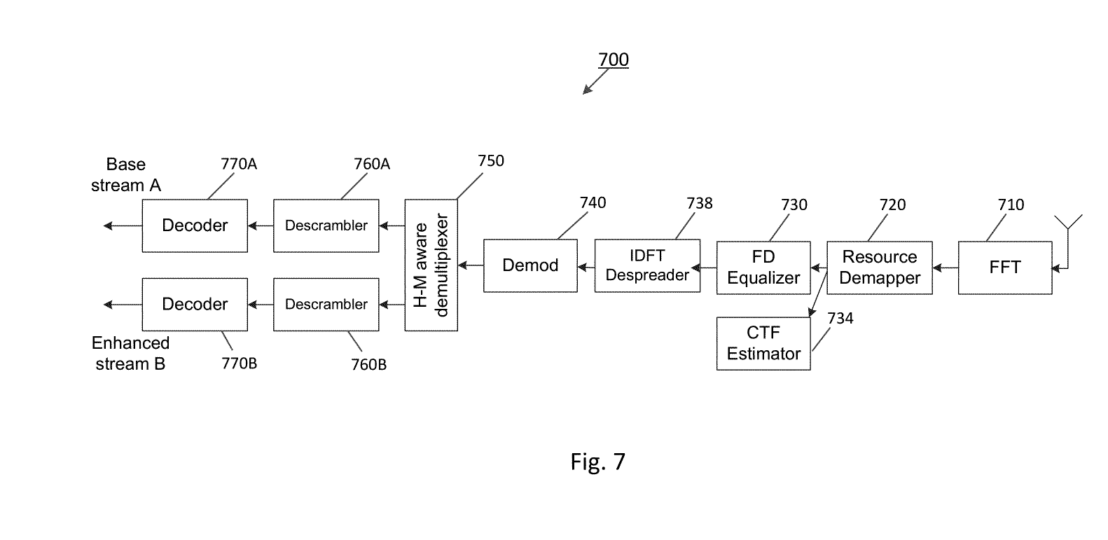

FIG. 7 illustrates a base station receiver 700 according to an aspect of the invention. Here, the base station receiver 700 is a hierarchical modulation aware receiver and facilitates single carrier frequency-division multiple access (SC-FDMA) multiplexing in, for example, an LTE uplink. One of ordinary skill in the art readily appreciates that receiver 700 may be adapted for use in other types of systems such as, but not limited to an orthogonal frequency-division multiple access (OFDMA) system, such as a WiMAX uplink, or an orthogonal frequency division multiplexing (OFDM) system such as the LTE downlink. One of ordinary skill in the art also understands how to map phase-shift keying (PSK) and QAM modulation to the OFDM subcarriers of OFDM, OFDMA and SC-FDMA transmissions, or to other transmission techniques such as single carrier transmissions.

The base station receiver 700 comprises a fast Fourier transform (FFT) algorithm 710, a resource demapper 720, a frequency domain equalizer 730, a channel transfer function (CTF) estimator 734, an inverse discrete Fourier transform (IDFT) despreader 738, and a demodulator 740. Implementation of the FFT algorithm 710, the resource demapper 720, the frequency domain equalizer 730, and the IDFT despreader 738 is readily known and apparent to one of ordinary skill in the art. Implementation of the CTF in the estimator 734 is described below.

The base station receiver 700 further comprises a demultiplexer 750, which demultiplexes the incoming data stream into base stream A and enhanced stream B. For example, the base station receiver 700 receives the stream, for instance, as QAM-16, and de-multiplexes the bits indicating the quadrant into stream A and the remaining bits into stream B. As described below with respect to receiving two QPSK transmissions as a single QAM-16 reception, the demodulator 750 may need to apply a different mapping of QAM constellation points to bits than is used with the well-known Gray coding that is typical of wireless communication systems. Base stream A is descrambled and decoded by descrambler 760A and decoder 770A, respectively. Enhanced stream B is descrambled and decoded by descrambler 760B and decoder 770B, respectively. Descramblers 760A and 760B, and decoders 770A and 770B, the implementation of all of which is apparent to one of ordinary skill in the art, may be omitted if scrambling and coding is not utilized on the transmission side

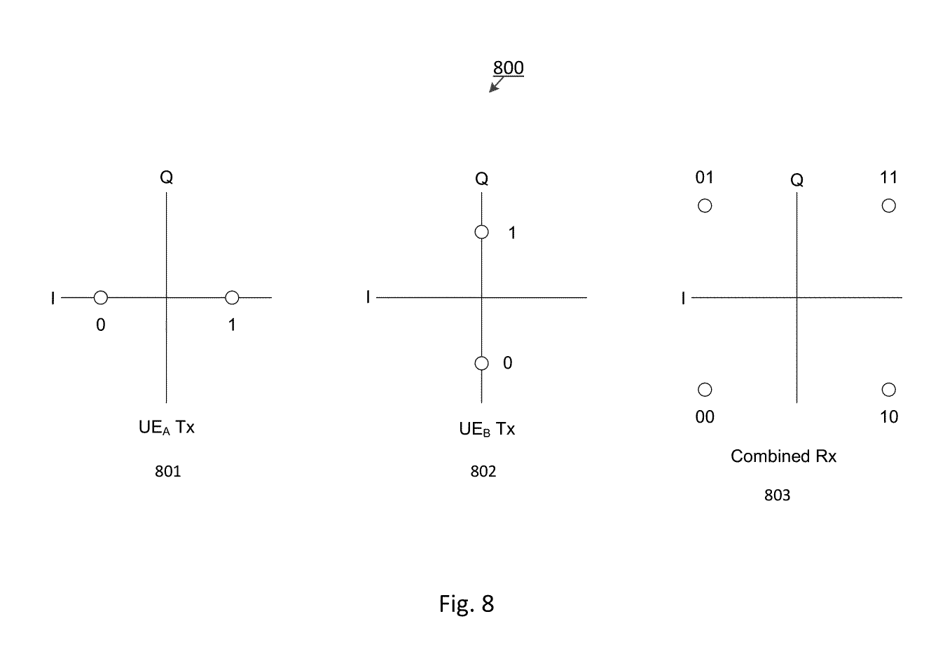

FIG. 8 illustrates a modulation scheme 800 for multiple streams from multiple transmitters (UE_{A} and UE_{B}) according to an aspect of the invention. Here, transmitters UE_{A} and UE_{B} are each transmitting its respective data stream (801 and 802) using binary phase shift keying (BPSK) modulation, but UE_{B}'s transmission 802 is phase shifted suitably to achieve a 90 degree rotation from UE_{A}'s transmission 801 when received by the base station 700. The resulting received signal 803 appears to the base station 700 as a QPSK signal and takes advantage of the orthogonal relationship of the two transmitted signals (801 and 802), allowing the base station 700 to receive both transmission streams using a single antenna. By coordinating the phase (e.g., via phase pre-rotation) alignment of the transmissions from UE_{A} and UE_{B}, the received quadrant of the QPSK signal preserves the phase of both signals relative to an axis crossing. Using the receiver design illustrated in FIG. 7, the base station receiver 700 can separate the bits back into the two original streams.

In an aspect of the invention, the base station coordinates the transmit powers of UE_{A} and UE_{B} in order to not saturate the base station receiver 700. One of ordinary skill in the art would understand that additional pre-adjustments based on an estimated channel transfer function or received signal strength for one or both UEs may also be applied. This allows a cell edge system capacity increase when individual UEs are required to transmit using the very robust BPSK modulation.

Additionally, the coding (assigning of binary bit values) of the BPSK transmissions causes the resulting QPSK reception to retain the appearance that it is coded with well-known Gray coding. This has the benefit that any adjacent constellation symbols differ by only one bit, minimizing bit errors during demodulation. The use of hierarchical modulation further isolates the bit error to a single one of data streams A and B. One of ordinary skill in the art understand that the present invention may be applied independently to different layers of an multi-user, multiple input, multiple output (MU-MIMO) transmission with the two BPSK UE_{A} and UE_{B} collectively acting as a single QPSK layer.

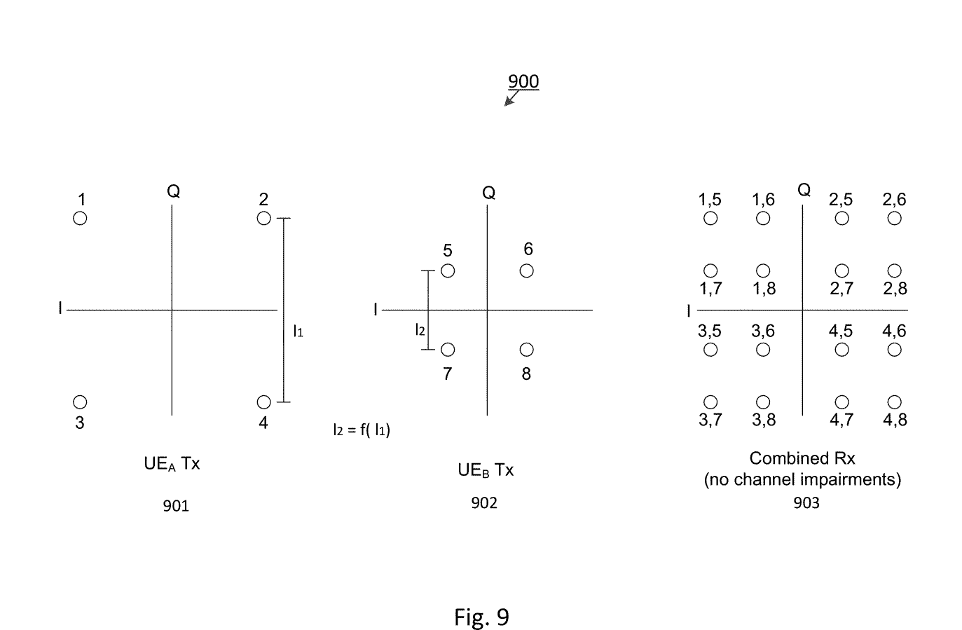

FIG. 9 illustrates a modulation scheme 900 for multiple streams from multiple transmitters (UE_{A} and UE_{B}) according to another aspect of the invention. Here, each UE is transmitting QPSK modulation, but UE_{A}'s transmission 901 and UE_{B}'s transmission 902 are configured to maintain a specific desired power and phase relationship (shown in 903) at the perspective of the base station receiver 700. Specifically, the Euclidean distance (i.e. shortest distance between two points) between two adjacent QPSK constellation points of UE_{B}'s transmission 902 may be chosen to ensure the resulting received constellation points are discernible from one another. For instance, the transmit power of UE_{B}'s transmission 902 may be chosen to result in received constellation points that are one half the Euclidean distance between two adjacent QPSK constellation points of UE_{A}'s transmission 901, as perceived by the base station receiver 700 (as shown in 903). The result 903 may appear to the base station as a QAM-16 signal. The base station receiver 700 may receive the transmissions from both UEs using a single antenna. Constellation points are numbered in 903 for convenience in identifying the combination of transmitted QPSK constellation points contributing to the received QAM-16 constellation points. Each transmitted QPSK constellation point represents 2 binary bits. Each received QAM-16 constellation point represents 4 binary bits. It should be appreciated that the invention can be utilized in various scenarios in which the transmitting devices (UEs) may use other combinations of modulation schemes chosen from BPSK, QPSK, DPSK, DQPSK, OQPSK and QAM.

To reduce inter-layer interference (ILI), which impedes the ability of base station receiver 700 to receive UE_{A}'s constellation due to the introduction of UE_{B}'s constellation, a power control system may be adjusted so that the Euclidean distance between two adjacent QPSK constellation points of UE_{B}'s transmission may be chosen to be less than one half the Euclidean distance between two adjacent QPSK constellation points of UE_{A}'s transmission from the perspective of the base station receiver 700. Such a configuration may be used, for instance, when the transmission from UE_{A} is deemed more important (e.g. a higher priority) than that of UE_{B}. Additionally, this technique may be used when the uncertainty of the channel transfer function for UE_{B} is large, and hence the ability to reliably adjust the phase/power of UE_{B}'s transmission is degraded. Alternatively, the relative powers of the respective transmissions may be based upon the devices' transmit power capabilities coupled with their distance from the base station receiver 700.

The transmit powers needed to support successful reception of multiple transmissions may be naturally occurring due to UE_{A} and UE_{B} being different distances from the base station or having different propagation paths (e.g., through a wall) or may be intentionally created via power control protocols as would be known to one skilled in the art. Power control adjustments may be made based upon the estimate of the CTF between each transmitting UE and the base station. For example in LTE, an uplink reference signal, transmitted by each device in a dedicated subcarrier and timeslot may be used by the CTF Estimator 734 to estimate the CTF and assess the received power for a given device transmit power. This CTF estimate may then be used to calculate the necessary transmit power for each transmitting device in order to obtain the desired combined received constellation resulting from transmissions from multiple devices. Similarly, the CTF estimate may be used to obtain the necessary phase pre-rotation for each transmitter. One of ordinary skill in the art appreciates that various known techniques may be utilized to estimate CTF and that the CTF estimation block 734 of the base station receiver 700 may take various forms.

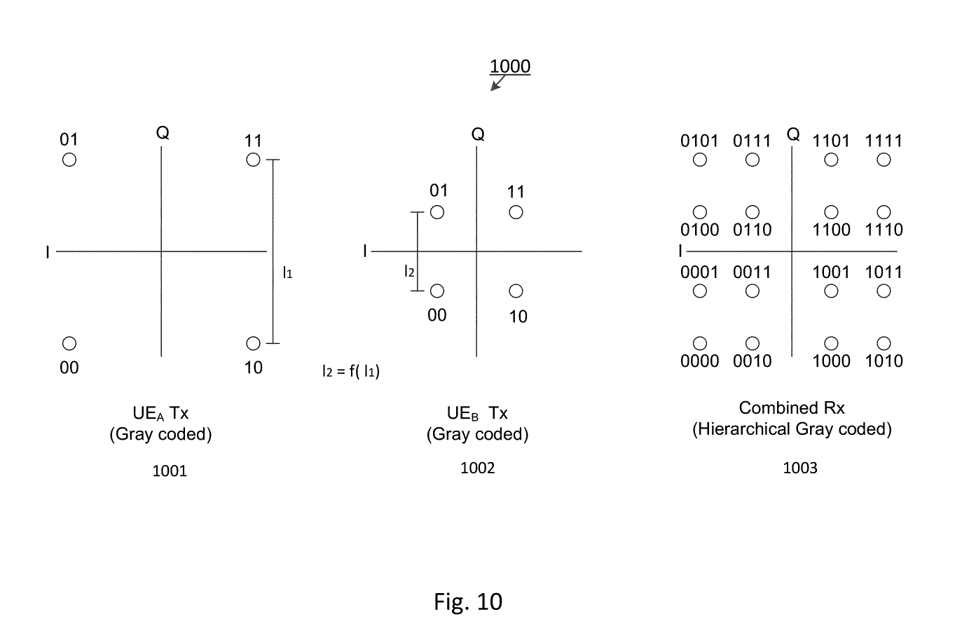

FIG. 10 illustrates a bit mapping 1000 onto the modulation scheme 900 of FIG. 9 utilizing Gray coding for multiple streams (1001 and 1002) from multiple transmitters (UE_{A} and UE_{B}) according to aspects of the invention. Here, the data to be transmitted for streams A (1001) and B (1002) is mapped to the transmitted QPSK constellation points using Gray coding, an advantage of which is retaining typical QAM transmitter architecture in the UEs. Mapping the two bits per QPSK symbol from stream A 1001 to the first and second bits represented by the received QAM-16 symbol 1003 and mapping the two bits per QPSK symbol from stream B 1002 to the third and fourth bits represented by the received QAM-16 symbol 1003 causes the received QAM-16 symbols to represent different binary bit combinations than would be expected if the symbols had been transmitted directly as Gray coded QAM-16. Constellation points within a quadrant preserve the feature that adjacent constellation points differ by only a single bit. Constellation points directly across the in-phase (I) axis or the quadrature phase (Q) axis from each other differ in two binary bits. However, the bits corresponding to an individual stream still differ by only a single bit. The benefits of Gray coding are preserved on the individual stream basis. This “hierarchical” Gray coding minimizes per stream bit errors. Other mapping of data to transmit constellations and, therefore, the interpretation of the received constellation may be used, the identification and implementation of which are apparent to one of ordinary skill in the art.

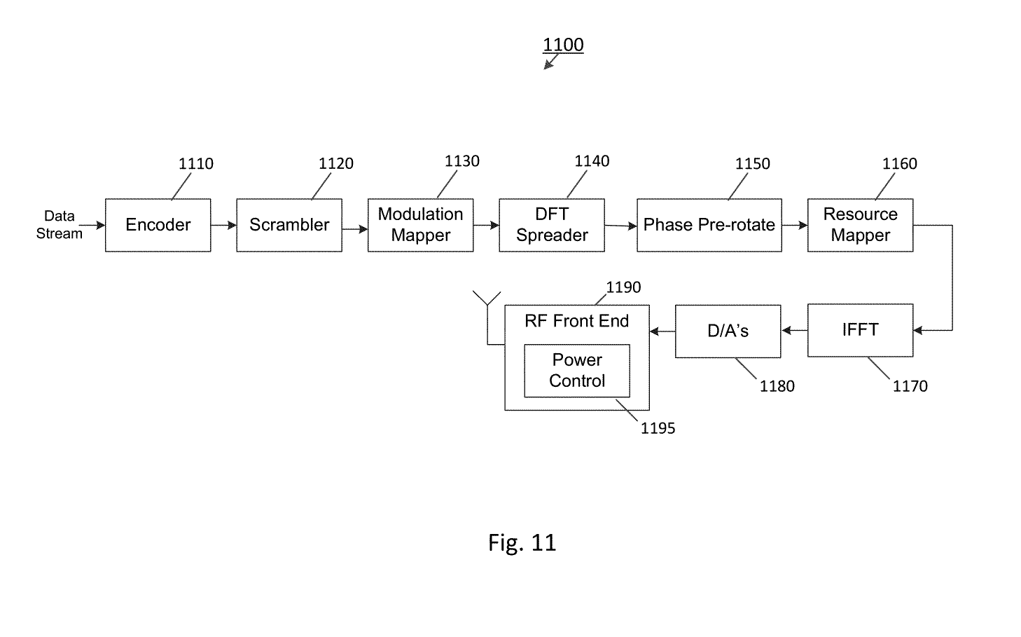

FIG. 11 illustrates a UE transmitter 1100 according to aspects of the invention. Here, UE transmitter 1100 (which forms a part of either UE_{A} and UE_{B}) comprises an encoder 1110, a scrambler 1120, a modulation mapper 1130, a discrete Fourier transform (DFT) spreader 1140, phase pre-rotate logic 1150, a resource mapper 1160, an inverse fast Fourier transform 1170, one or more digital to analog converters 1180, and a radio frequency (RF) front end 1190 comprising power control logic 1195. In each of the BPSK, QPSK, and QAM cases above, UE_{A} and UE_{B} may be requested to pre-adjust their transmission to maintain proper phase alignment (e.g., via phase pre-rotation logic 1150) and receive amplitude (e.g., via power control logic 1195) of the combined received constellation points. In this regard, power control logic 1195 may be used at both UE_{A} and UE_{B} to set their respective power level appropriately to allow for reception of both transmissions at once using hierarchical modulation rather than receiving each transmission individually. Implementation of the encoder 1110, the scrambler 1120, the modulation mapper 1130, the DFT spreader 1140, the resource mapper 1160, the inverse fast Fourier transform (IFFT) 1170, the one or more digital to analog converters (D/A) 1180, and the radio frequency (RF) front end 1190 is readily known and apparent to one of ordinary skill in the art.

One of ordinary skill in the art knows that the phase pre-rotation logic 1150 may alternatively be employed before the DFT spreader 1140. The location of the DFT spreader 1140 allows a trade-off between correcting more for flat fading or more for frequency-selective fading. In an aspect of the invention, the power control logic 1195 may be implemented, in part, in digital portions of the transmitter instead of entirely in the RF front end 1190.

The base station employs the hierarchical modulation aware receiver 700 but, unlike MIMO, it can receive the streams A and B using a single antenna. In order to properly pre-rotate the phase and control the power of each transmission stream A and B, the base station may periodically or as needed command UE_{A} and UE_{B} to transmit individually (i.e., not using hierarchical modulation) in order to estimate the needed phase pre-rotation and power control. In alternate aspects, the base station may send a command to UE_{A} and UE_{B} commanding them to transmit periodically and individually (i.e., not using hierarchical modulation) in order to estimate the needed phase pre-rotation and power control. In other alternate aspects, transmissions by UE_{A} and UE_{B} for the purpose of estimating the needed phase pre-rotation and power control may be made simultaneously by using suitable pilot signals such as orthogonal pilots. The orthogonality of the pilots may be ascertained through selecting orthogonal frequency resources for pilots or by using pilot reference signals (such as Zadoff Chu based sequences of LTE). The base station may command the phase pre-rotation and power control as part of an uplink map or other command or information describing the transmit opportunity and parameters to the UEs. Alternatively, phase pre-rotation and power control may be commanded by individual messages to the respective UEs prior to the uplink transmission. Phase pre-rotation and power control may be conveyed in the same messages or in separate messages.

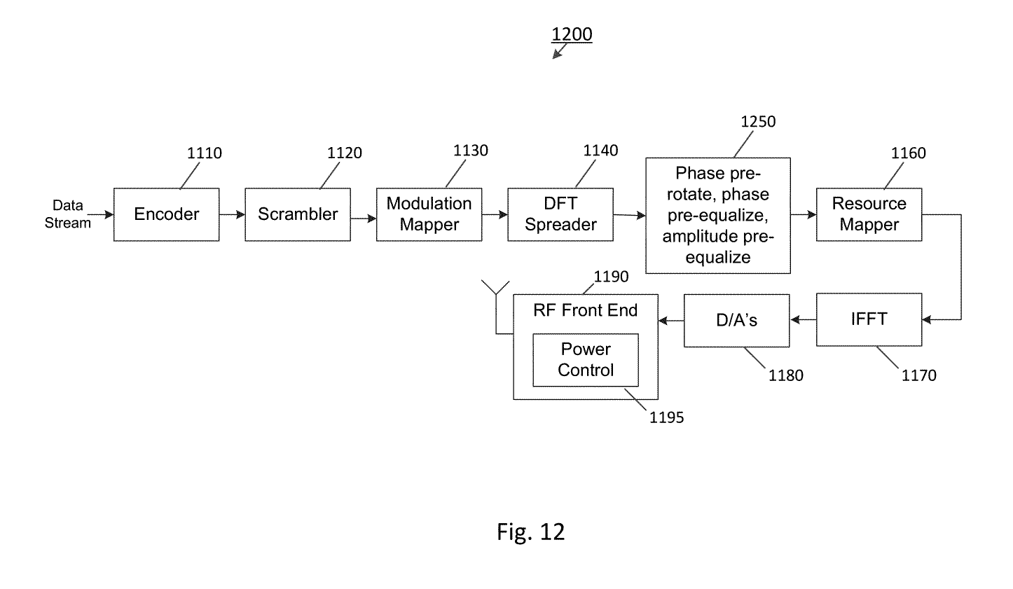

FIG. 12 illustrates a UE transmitter 1200 according to other aspects of the invention. Here, the UE transmitter 1200 (which forms a part of either UE_{A} or UE_{B}) is similar to the UE transmitter 1100 of FIG. 11; however, the UE transmitter 1200 includes phase pre-rotate, phase pre-equalize, and amplitude pre-equalize logic 1250 (instead of phase pre-rotate logic 1150) to further pre-equalize amplitude and phase across the sub-carriers of its transmission to account for frequency-selective fading. Pre-equalization against frequency selective channels is most easily conducted after the DFT spreader 1140. In an aspect, some functions of 1250 are performed before DFT Spreader 1140 and some are performed after DFT Spreader 1140. The UE transmitter 1200 performs amplitude pre-equalization and phase pre-equalization so that when equalized at the base station receiver 700, the sub-carriers of the stream are at desired relative amplitude levels and phase. If the channel from the UE transmitter 1200 to the base station receiver 700 is frequency non-selective over the subcarriers of the transmission, pre-equalization against phase and amplitude distortion in the channel may be conducted either before or after the DFT spreader 1140. Pre-equalization can attempt to align the amplitude and phase responses across the transmission bandwidth based on the transmitting device's CTF profile when received at base station receiver, or to a desired profile (including targeting a uniform overall transfer function).

Similar to commanding phase pre-rotation and power control, the base station receiver 700 may command phase pre-equalization and amplitude pre-equalization as part of an uplink map or other information describing the transmit opportunity and parameters to the UEs. Alternatively, phase pre-equalization and amplitude pre-equalization may be commanded by individual messages to one or more of the UEs prior to the transmission. The commanding of phase pre-rotation, power control, phase pre-equalization, and amplitude pre-equalization may be performed separately or in combined messaging.

One of ordinary skill in the art appreciates that, since the I and the Q components sum independently, the above example with two QPSK transmitters creates a received 16-QAM constellation because the transmission received with a lower amplitude from UE_{B} is effectively shifted such that the origin of its I, Q axis is centered on the currently received constellation point transmitted by UE_{A}. The same relationship holds in reverse. That is, the transmission received with a higher amplitude from UE_{A} is also effectively shifted such that the origin of its I, Q axis is centered on the currently received constellation point transmitted by UE_{B}. The following examples set forth below use the perspective that the lower amplitude constellation is shifted on the higher amplitude constellation.

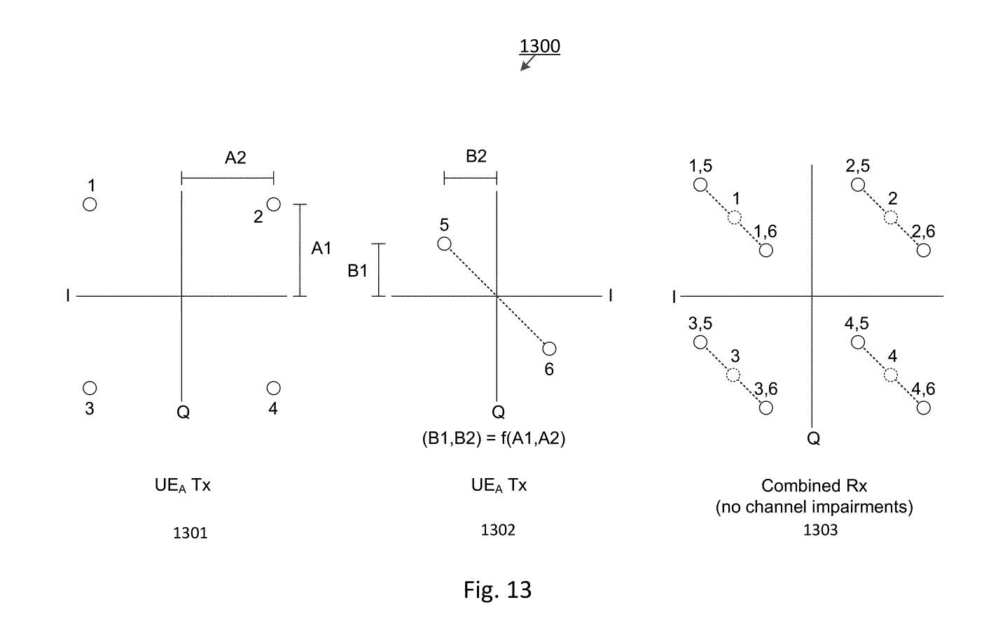

FIG. 13 illustrates a modulation scheme 1300 for multiple streams (1301 and 1302) from multiple transmitters (UE_{A} and UE_{B}) according to an aspect of the invention. Here, UE_{A} is transmitting using a QPSK constellation 1301 and UE_{B} is transmitting using a BPSK constellation 1302. The constellations have been phase pre-aligned and power controlled (as well as possibly amplitude pre-equalized) so that the BPSK constellation as received at the receiver 1303 is rotated 45 degrees off the Q axis and the power is received at the receiver at a lower amplitude than the signal received from UE_{A}. This causes each symbol, in time, of the BPSK constellation to appear to the receiver to be modulated around the simultaneous symbol of the QPSK constellation, providing more information. In the example of FIG. 13, it is noted that the 45 degree rotation is for example only. B1 is the deviation of constellation B from the I axis and B2 is the deviation of constellation B from the Q axis. Similarly, A1 is the deviation of constellation A from the I axis and A2 is the deviation of constellation A from the Q axis. B1 and B2 do not need to be equal. Additionally, constellation A may be rotated as well, or instead, i.e., A1 and A2 need not be equal. B1 and B2 are functions of A1 and A2 to the extent necessary to have discernible points in the resulting received constellation. A dashed line is shown in the constellation of UE_{B} between BPSK constellation points 5 and 6 to illustrate their relationship in I, Q space. The received constellation for the combined signals with BPSK constellation points 5 and 6 overlaid on the original QPSK constellation A points 1, 2, 3, and 4, is shown in 1303 with dashed outlines indicating the original QPSK constellation A points for reference and solid outlines indicating the combined constellation points.

Two sinusoidal signals, such as those transmitted by UE_{A} and UE_{B} can each be represented as a complex value or a phasor. The received combination of the two signals can be described by the vector addition of the two transmit phasors. Hence, when UE_{A} transmits a constellation point, it becomes the new origin for the constellation transmitted by UE_{B}. For example, if UE_{A} transmits constellation point 1 and UE_{B} transmits constellation point 5, the I and Q contributions combine, resulting in constellation point (1,5). Similarly, if UE_{B} transmitted constellation point 6 the combination would yield constellation point (1,6). The dashed line connecting constellation points (1,5) and (1,6) is analogous to the dashed line connecting constellation points 5 and 6 to illustrate the shifted perspective.

One of ordinary skill in the art understands that the concepts and techniques introduced herein are not limited to two transmitters. Adding a third transmitter UE_{C} with appropriately pre-aligned phase, power control, and pre-equalized amplitude would result in yet another level of constellations with origins shifted to be centered on constellation points (1,5), (1,6), (2,5), etc. The number of levels achievable is a function of the ability of the receiver to accurately discern differences in phase and amplitude, much the same as the achievable order of QAM modulation, (e.g. QAM-16 versus QAM-1024), is a function of the ability of the receiver to accurately discern differences in phase and amplitude in its current noise and interference environment.

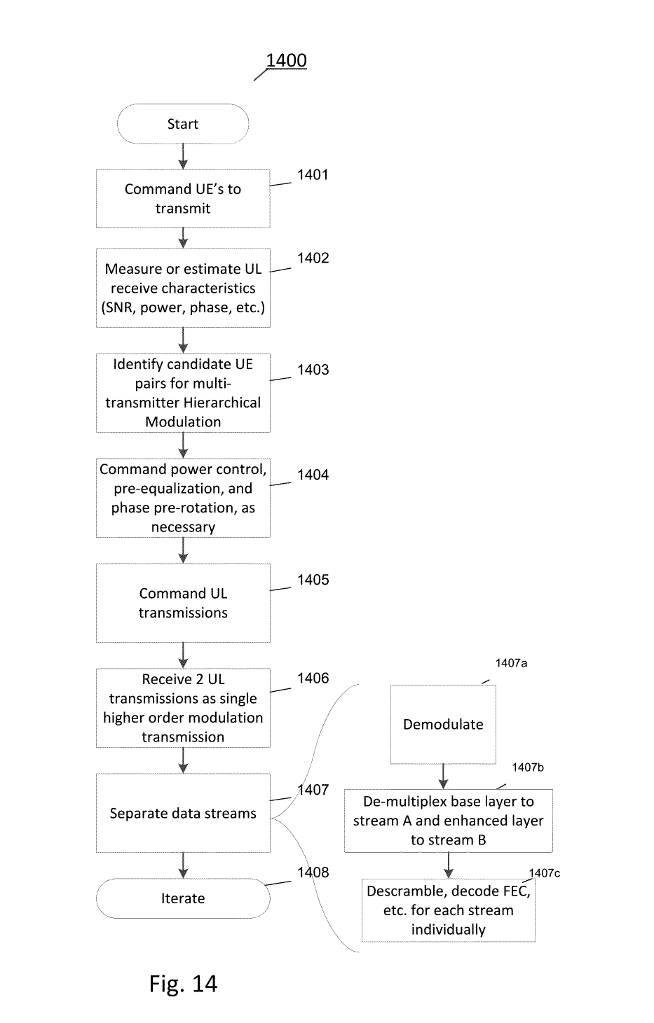

FIG. 14 illustrates a method 1400 to command the uplink transmissions of two UEs (e.g., UE_{A} and UE_{B}) in a multi-transmitter hierarchical modulation scheme according to an aspect of the invention. Particularly, the base station benefits from understanding receive characteristics, such as phase rotation, received power, and CTF, for uplink transmissions from each of the candidate UEs. The base station may determine these receive characteristics by receiving transmissions from each of the UEs where such transmissions are not part of a multi-transmitter hierarchical modulation transmission. For example, a wireless system may use dedicated reference signals to estimate the CTF (e.g., the phase shift and amplitude attenuation due to propagation characteristics). The base station commands (step 1401) the UEs to transmit. For example, the base station may schedule the individual transmissions to be periodic, or the base station may schedule the individual transmissions on an as needed or event driven basis, for example scheduling such transmissions immediately prior to scheduling UEs to participate in multi-transmitter hierarchical modulation transmissions.

When the base station receives the uplink transmissions of the UEs, the base station measures or estimates (step 1402) receive characteristics (e.g., signal to interference plus noise ratio (SINR), power, phase, CTF, etc.) of the uplink transmissions. These receive characteristics may be used to determine the amount of phase pre-rotation and transmit power adjustment needed to create a suitable combined receive constellation. These receive characteristics may also be used to establish phase and amplitude pre-equalization adjustments.

Based on the receive characteristics, the base station identifies (step 1403) pairs of UEs suitable for multi-transmitter uplink hierarchical modulation transmissions. Candidates may be paired based on each UE's received SINR, receiver error vector magnitude (EVM), available transmission power dynamic range (both amount of possible power increase or decrease) or other characteristics detected at the base station. For example, the base station may build a list of UEs and their respective SINR values. The list may be sorted by SINR. UEs may be paired starting with the two UEs having the highest SINR, then moving on to the pair with the next highest SINR, and so on. Alternatively, UEs with SINR below a threshold value may be removed from the sorted list. UEs may then be paired starting with the UEs with the highest and lowest SINR, then moving to the pair with the second highest and second lowest SINR, and so on. UEs with lower SINR may be considered as UE_{A} transmitters while UEs with higher SINR may be considered as UE_{B} transmitters. UE pairing may be performed or adjusted based on whether there is data pending to transmit from each UE. For example, the UE list described above may include only those UEs with data pending.

For multi-transmitter uplink hierarchical modulation transmissions, the base station commands (step 1404) the participating UEs to modify transmission characteristics such as phase rotation, phase pre-equalization, amplitude pre-equalization, and transmit power. These modifications may be commanded, for example, as part of one or more uplink bandwidth grants that instructs the UEs to transmit in the uplink at specific modulation, coding, power, and using specific resources. Alternatively, the transmit characteristics may be commanded via messaging to the UEs that is separate from bandwidth grants. In either case, the base station commands (step 1405) the UEs to transmit simultaneously in the uplink. One of ordinary skill in the art understands that one or more of phase rotation, phase pre-equalization, amplitude pre-equalization, and power control may be omitted if unnecessary for the base station receiver 700 to discern the multiple transmissions.

Alternatively, the determination of how to adjust phase rotation, transmit power and phase/amplitude pre-equalization may be made by each UE. In this scenario, the base station informs each UE that it is part of a UE pair for a particular bandwidth grant, whether it is to act as UE_{A} or UE_{B}, and informs the UE of its uplink CTF. Based on this information, the UE can determine the necessary adjustments using methods similar to those described for the base station.

One of ordinary skill in the art understands that the steps of scheduling individual transmissions, determining receive characteristics, and identifying candidate pairs of UEs may happen more or less frequently than the steps of commanding UEs to transmit simultaneously. In particular, pairs of candidate UEs may be commanded to transmit simultaneously in multi-transmitter uplink hierarchical modulation transmissions a plurality of times before the base station takes new individual receive characteristics measurements. The frequency of the measurements may be based on derived information such as the movement speed of the UE, for example.

After commanding the multi-UE uplink hierarchical modulation transmissions, the base station receives (step 1406) the transmissions as a single higher order (hierarchical) modulation transmission. The received data is separated (step 1407) by the base station back into two streams by demodulating the signal into a bit stream (step 1407a), de-multiplexing the bit stream into two bit streams (step 1407b), and performing any remaining signal processing steps, such as descrambling or FEC decode, for each of the two streams (step 1407c).

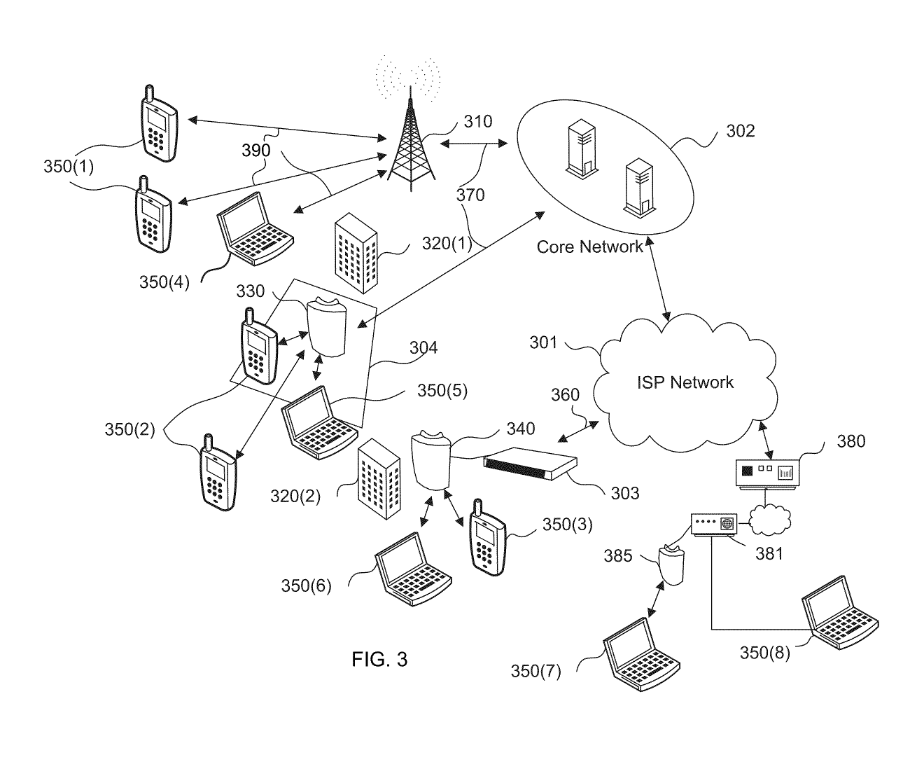

Descriptions of exemplary systems and components for implementing aspects of the invention are further described now with regard to FIGS. 3 to 6. FIG. 3 is a communication network in which features disclosed herein can be implemented in accordance with aspects of the invention. A macro base station (access node) 310 is connected to a core network 302 through a backhaul connection 370. In an aspect, the backhaul connection 370 is a bidirectional link or two unidirectional links. The direction from the core network 302 to the macro base station 310 is referred to as the downstream or downlink direction. The direction from the macro base station 310 to the core network 102 is referred to as the upstream or uplink direction. Subscriber stations 350(1) and 350(4) can connect to the core network 302 through the macro base station 310. Wireless links 390 between subscriber stations 350(1) and 350(4) and the macro base station 310 are bidirectional point-to-multipoint links, in an aspect. The direction of the wireless links 390 from the macro base station 310 to the subscriber stations 350(1) and 350(4) is referred to as the downlink or downstream direction. The direction of the wireless links 390 from the subscriber stations 350(1) and 350(4) to the macro base station 310 is referred to as the uplink or upstream direction. Subscriber stations are sometimes referred to as user equipment, users, user devices, handsets, terminal nodes, or user terminals and are often mobile devices such as smart phones or tablets. The subscriber stations 350(1) and 350(4) access content over the wireless links 390 using base stations, such as the macro base station 310, as a bridge. That is to say, the base stations generally pass user application data and any user application control messages between the subscriber stations 350(1) and 350(4) and the core network 302 without the base station being a destination for the data and control messages or a source of the data and control messages.

In the network configuration illustrated in FIG. 3 an office building 320(1) causes a coverage shadow 304. A pico station 330 can provide coverage to subscriber stations 350(2) and 350(5) in the coverage shadow 304. The pico station 330 is connected to the core network 302 via a backhaul connection 370. The subscriber stations 350(2) and 350(5) may be connected to the pico station 330 via links that are similar to or the same as the wireless links 390 between subscriber stations 350(1) and 350(4) and the macro base station 310.

In office building 320(2), an enterprise femtocell 340 provides in-building coverage to subscriber stations 350(3) and 350(6). The enterprise femtocell 340 can connect to the core network 302 via an internet service provider network 301 by utilizing a broadband connection 360 provided by an enterprise gateway 303.

In addition, internet service provider network 301 may also provide a broadband connection between core network 302 and cable head end 380, which may be a cable head end of a local, regional or national digital cable service. Cable head end 380 is connected to a large number of set top boxes and cable modems, such as cable modem 381, by a network of cables or other wired connections. Cable modem 381 may be provided in a residence or a business location and provides internet connectivity to subscriber stations 350(7) and 350(8). In this regard, cable modem 381 is connected to access point 385 which provides wireless coverage to subscriber station 350(7) via a wi-fi (802.11) wireless connection. Subscriber station 350(8) may be directly wired to cable modem 381 via an Ethernet connection or other wired connection.

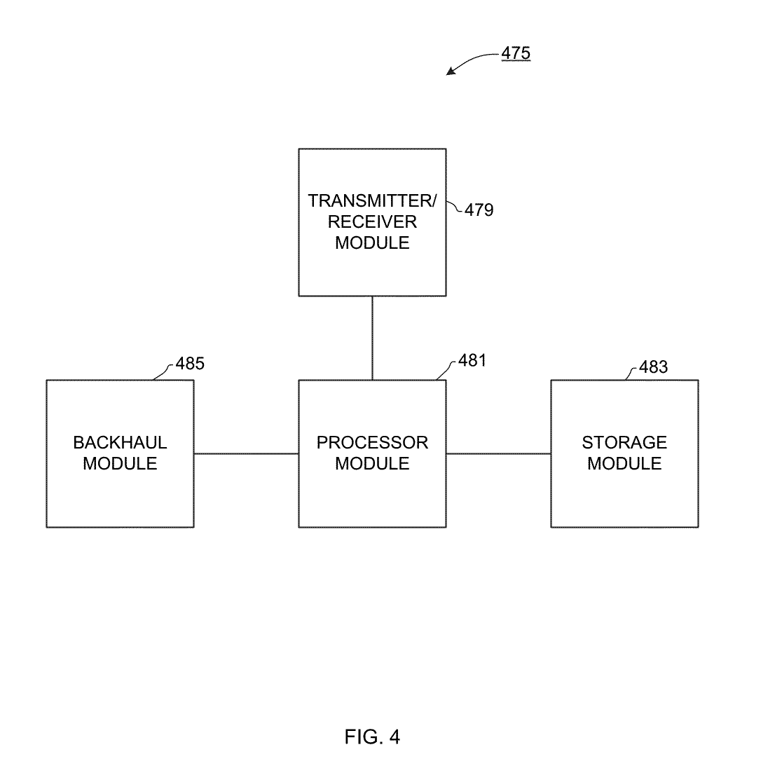

FIG. 4 is a functional block diagram of an access node 475 in accordance with aspects of the invention. In various aspects, the access node 475 may be a mobile WiMAX base station (BS), a Universal Mobile Telecommunications System (UMTS) NodeB, an LTE evolved Node B (eNB or eNodeB), a cable modem head end, or other wireline or wireless access node of various form factors. For example, the macro base station 310, the pico station 330, or the enterprise femtocell 340 of FIG. 3 may be provided, for example, by the access node 475 of FIG. 4. The access node 475 includes a processor module 481. The processor module 481 is coupled to a transmitter-receiver (transceiver) module 479, a backhaul interface module 485, and a storage module 483.

The transmitter-receiver module 479 is configured to transmit and receive communications with other devices. For example, transmitter-receiver module 479 may incorporate receiver 700 of FIG. 7, as described above. In many implementations, the communications are transmitted and received wirelessly. In such implementations, the access node 475 generally includes one or more antennae for transmission and reception of radio signals. In other implementations, the communications are transmitted and received over physical connections such as wires or optical cables. The communications of the transmitter-receiver module 479 may be with terminal nodes.

The backhaul interface module 485 provides communication between the access node 475 and a core network. The communication may be over a backhaul connection, for example, the backhaul connection 370. Communications received via the transmitter-receiver module 479 may be transmitted, after processing, on the backhaul connection. Similarly, communication received from the backhaul connection may be transmitted by the transmitter-receiver module 479. Although the access node 475 of FIG. 4 is shown with a single backhaul interface module 485, other aspects of the access node 475 may include multiple backhaul interface modules. Similarly, the access node 475 may include multiple transmitter-receiver modules. The multiple backhaul interface modules and transmitter-receiver modules may operate according to different protocols.

The processor module 481 can process communications being received and transmitted by the access node 475. The storage module 483 stores data for use by the processor module 481. The storage module 483 may also be used to store computer readable instructions for execution by the processor module 481. The computer readable instructions can be used by the access node 475 for accomplishing the various functions of the access node 475. In an aspect, the storage module 483 or parts of the storage module 483 may be considered a non-transitory machine readable medium. For concise explanation, the access node 475 or aspects of it are described as having certain functionality. It will be appreciated that in some aspects, this functionality is accomplished by the processor module 481 in conjunction with the storage module 483, transmitter-receiver module 479, and backhaul interface module 485. Furthermore, in addition to executing instructions, the processor module 481 may include specific purpose hardware to accomplish some functions.

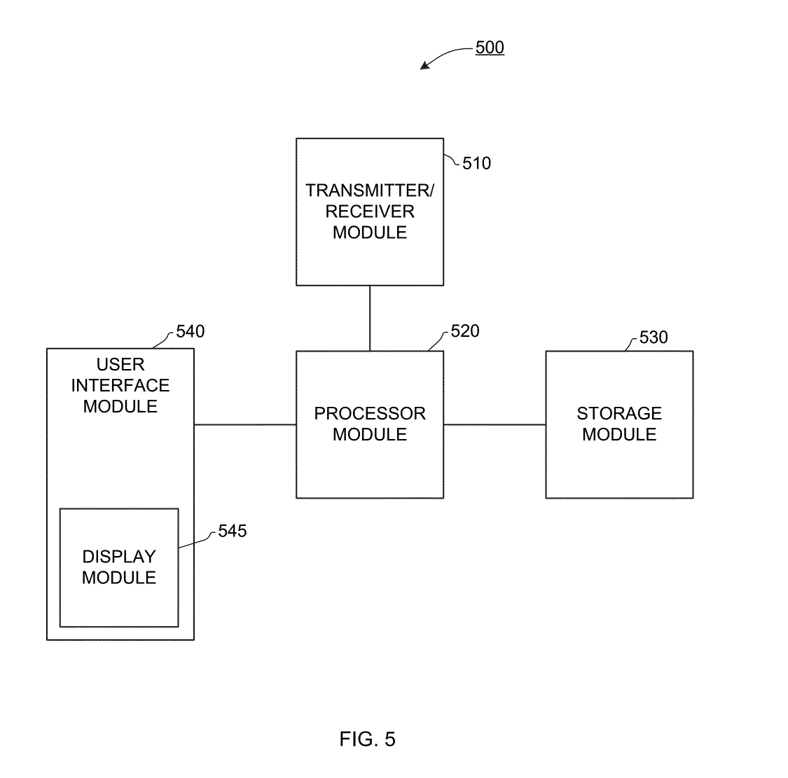

FIG. 5 is a functional block diagram of a terminal node in accordance with aspects of the invention. The terminal node 500 can be used for viewing streaming video. In various exemplary aspects, the terminal node 500 may be a mobile device, for example, an LTE user equipment (UE), a mobile phone, a cellular phone, a WiMAX subscriber station, a mobile subscriber station, a smartphone, a tablet or a notebook computer. The terminal node 500 includes a processor module 520. The processor module 520 is communicatively coupled to transmitter-receiver module (transceiver) 510, user interface module 540, and storage module 530. The processor module 520 may be a single processor, multiple processors, or a combination of one or more processors and additional logic such as application-specific integrated circuits (ASIC) or field programmable gate arrays (FPGA).

The transmitter-receiver module 510 is configured to transmit and receive communications with other devices. In this regard, transmitter-receiver module 510 may be, for example, transmitter 1100 of FIG. 11 or transmitter 1200 of FIG. 12. The transmitter-receiver module 510 may communicate with a cellular or broadband base station such as an LTE evolved node B (eNodeB) or WiFi access point (AP). In exemplary aspects where the communications are wireless, the terminal node 500 generally includes one or more antennae for transmission and reception of radio signals. In other example aspects, the communications may be transmitted and received over physical connections such as wires or optical cables and the transmitter/receiver module 510 may be an Ethernet adapter or cable modem. Although the terminal node 500 is shown with a single transmitter-receiver module 510, other exemplary aspects of the terminal node 500 may include multiple transmitter-receiver modules. The multiple transmitter-receiver modules may operate according to different protocols.

The terminal node 500, in some exemplary aspects, provides data to and receives data from a person (user). Accordingly, the terminal node 500 includes a user interface module 540. The user interface module 540 includes modules for communicating with a person. The user interface module 540, in an exemplary aspect, may include a display module 545 for providing visual information to the user, including displaying video content. In some exemplary aspects, the display module 545 may include a touch screen which may be used in place of or in combination with a keypad connected to the user interface module 540. The touch screen may allow graphical selection of inputs in addition to alphanumeric inputs.

In alternative exemplary aspects, the user interface module 540 may include a computer interface, for example, a universal serial bus (USB) interface, to interface the terminal node 500 to a computer. For example, a wireless modem, such as a dongle, may be connected, by a wired connection or a wireless connection, to a notebook computer via the user interface module 540. Such a combination may be considered to be a terminal node 500. The user interface module 540 may have other configurations and include hardware and functionality such as speakers, microphones, vibrators, and lights.

The processor module 520 can process communications received and transmitted by the terminal node 500. The processor module 520 can also process inputs from and outputs to the user interface module 540. The storage module 530 may store data for use by the processor module 520, including images or metrics derived from images. The storage module 530 may also be used to store computer readable instructions for execution by the processor module 520. The computer readable instructions can be used by the terminal node 500 for accomplishing the various functions of the terminal node 500. Storage module 530 can also store received content, such as video content that is received via transmitter/receiver module 510.

The storage module 530 may also be used to store photos and videos. In an exemplary aspect, the storage module 530 or parts of the storage module 530 may be considered a non-transitory machine readable medium. In an exemplary aspect, storage module 530 may include a subscriber identity module (SIM) or machine identity module (MIM).

For concise explanation, the terminal node 500 or exemplary aspects of it are described as having certain functionality. It will be appreciated that in some exemplary aspects, this functionality is accomplished by the processor module 520 in conjunction with the storage module 530, the transmitter-receiver module 510 and the user interface module 540. Furthermore, in addition to executing instructions, the processor module 520 may include specific purpose hardware to accomplish some functions.

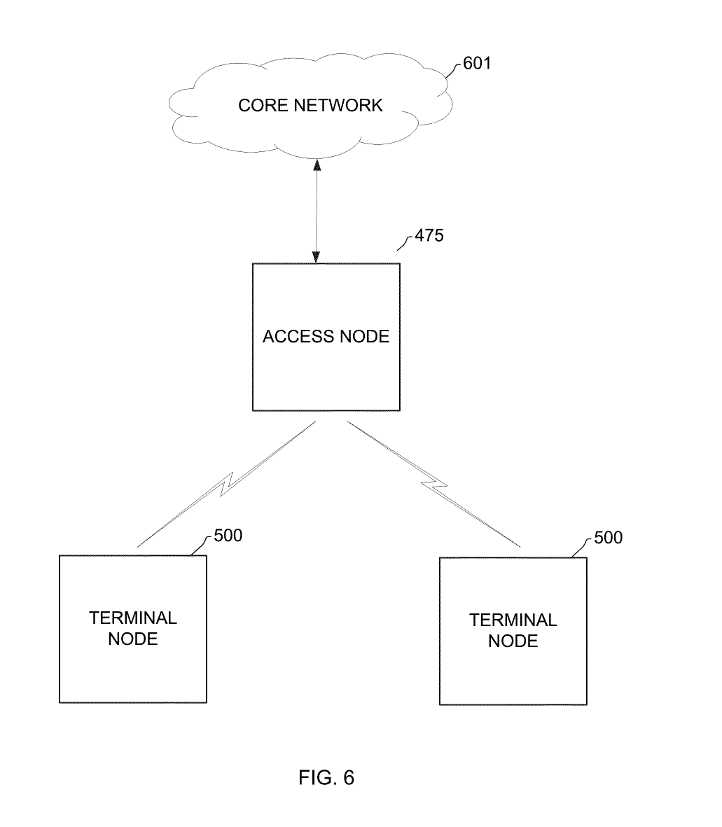

FIG. 6 illustrates an exemplary communication network that includes the access node of FIG. 4 and terminal node(s) of FIG. 5. Specifically, access node 475 is shown in FIG. 6 to be in communication with terminal nodes 500 such as, for example, via wireless communication links between terminal nodes 500 and access node 475. In exemplary aspects, communication is conducted via transmitter-receiver module 479 of access node 475 and transmitter-receiver module 510 of terminal nodes 500. As seen in FIG. 6, access node 475 is in communication with core network 601, which may be implemented by, for example, backhaul module 485 of access node 475. The foregoing described aspects and features are susceptible to many variations. Additionally, for clarity and concision, many descriptions of the aspects and features have been simplified. For example, the figures generally illustrate one of each type of device (e.g., one access node, one terminal node), but a communication system may have many of each type of device. Similarly, many descriptions use terminology and structures of a specific wireless standard such as LTE and the like. However, the disclosed aspects and features are more broadly applicable, including for example, other types of video transfer protocols and other types of communication systems.

Those of skill will appreciate that the various illustrative logical blocks, modules, units, and algorithm steps described in connection with the aspects disclosed herein can often be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular constraints imposed on the overall system. Skilled persons can implement the described functionality in varying ways for each particular system, but such implementation decisions should not be interpreted as causing a departure from the scope of the invention. In addition, the grouping of functions within a unit, module, block, or step is for ease of description. Specific functions or steps can be moved from one unit, module, or block without departing from the invention.

The various illustrative logical blocks, units, steps and modules described in connection with the aspects disclosed herein, and those provided in the accompanying documents, can be implemented or performed with a processor, such as a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein, and those provided in the accompanying documents. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

The steps of a method or algorithm and the processes of a block or module described in connection with the aspects disclosed herein, and those provided in the accompanying documents, can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium. An exemplary storage medium can be coupled to the processor such that the processor can read information from, and write information to, the storage medium. In the alternative, the storage medium can be integral to the processor. The processor and the storage medium can reside in an ASIC. Additionally, device, blocks, or modules that are described as coupled may be coupled via intermediary device, blocks, or modules. Similarly, a first device may be described a transmitting data to (or receiving from) a second device when there are intermediary devices that couple the first and second device and also when the first device is unaware of the ultimate destination of the data.

The above description of the disclosed aspects, and that provided in the accompanying documents, is provided to enable any person skilled in the art to make or use the invention. Various modifications to these aspects will be readily apparent to those skilled in the art, and the generic principles described herein, and in the accompanying documents, can be applied to other aspects without departing from the spirit or scope of the invention. Thus, it is to be understood that the description and drawings presented herein, and presented in the accompanying documents, represent particular aspects of the invention and are therefore representative examples of the subject matter that is broadly contemplated by the present invention. It is further understood that the scope of the present invention fully encompasses other aspects that are, or may become, obvious to those skilled in the art and that the scope of the present invention is accordingly not limited by the descriptions presented herein, or by the descriptions presented in the accompanying documents.

What we claim is:

1. A method for a receiving device to coordinate transmissions from a first transmitting device and from a second transmitting device of a plurality of transmitting devices to the receiving device in a communication network, the method comprising the steps of:
sending, from the receiving device, a first instruction to the first transmitting device to transmit a first signal according to first transmission characteristics, wherein the first signal comprises a base layer data stream;
sending, from the receiving device, a second instruction to the second transmitting device to transmit a second signal according to second transmission characteristics, wherein the second signal comprises an enhanced layer data stream;
receiving, at the receiving device, a hierarchical modulation signal comprising the first signal and the second signal being simultaneously transmitted; and
separating, at the receiving device, the base layer data stream and the enhanced layer data stream from the received hierarchical modulation signal.

2. The method of claim 1, wherein at least one of the first transmission characteristics and the second transmission characteristics comprise one or more of the following: a power parameter, a phase rotation parameter, a phase equalization parameter, and an amplitude equalization parameter.

3. The method of claim 1, further comprising the steps of:
estimating first channel characteristics associated with the first transmitting device and second channel characteristics associated with the second transmitting device; and
determining the first transmission characteristics and the second transmission characteristics based on the first channel characteristics and the second channel characteristics, respectively.

4. The method of claim 3, wherein the first channel characteristics and the second channel characteristics are based on one or more of the following: a signal to noise ratio indication, a signal to noise plus interference ratio indication, a receive error vector magnitude indication, a received power and received phase indication.

5. The method of claim 3, wherein the first channel characteristics and the second channel characteristics each comprise a channel transfer function.

6. The method of claim 3, wherein the first transmission characteristics and the second transmission characteristics are each based at least in part on an available transmission power dynamic range.

7. The method of claim 1, further comprising the steps of:
estimating channel characteristics associated with each of the plurality of transmitting devices; and
selecting the first transmitting device and the second transmitting device from the plurality of transmitting devices based on the estimated channel characteristics for each of the plurality of transmitting devices.

8. The method of claim 7, wherein the estimated channel characteristics for each of the plurality of transmitting devices are based on at least one of the following: a signal to noise ratio indication, a signal to noise plus interference ratio indication, a received error vector magnitude indication, and a received power and received phase indication.

9. The method of claim 7, wherein the estimated channel characteristics for each of the plurality of transmitting devices comprise a channel transfer function.

10. The method of claim 7, wherein the estimated channel characteristics for each of the plurality of transmitting devices are based at least in part on an available transmission power dynamic range.

11. The method of claim 7, wherein the first transmission characteristics and the second transmission characteristics each comprise one or more of the following: a power parameter, a phase rotation parameter, a phase equalization parameter, and an amplitude equalization parameter.

12. The method of claim 1, wherein the first transmission characteristics are contained in the first instruction, and the second transmission characteristics are contained in the second instruction.

13. The method of claim 12, wherein the first instruction and the second instruction are transmitted to the first transmitting device and the second transmitting device, respectively, within one or more bandwidth grants.

14. A method in a first transmitting device within a communication network for coordinating a transmission of a first signal from the first transmitting device to a receiving device with a transmission of a second signal from a second transmitting device to the receiving device, the method comprising the steps of:
receiving, at the first transmitting device, transmission information associated with transmission of the first signal, wherein the first signal comprises a base layer data stream or an enhanced layer data stream; and
transmitting, from the first transmitting device, the first signal according to the received transmission information, wherein the first signal is transmitted simultaneously with the second signal from the second transmitting device, the first signal and the second signal together forming a hierarchical modulation signal.

15. The method of claim 14, wherein the transmission information comprises one or more of the following: a power adjustment, a phase rotation parameter, a phase equalization parameter, and an amplitude equalization parameter.

16. The method of claim 14, wherein the transmission information comprises a channel transfer function associated with the first transmitting device.

17. The method of claim 14, wherein the transmission information comprises channel characteristics associated with the first transmitting device.

18. The method of claim 17, wherein the channel characteristics comprise at least one of the following: a signal to noise ratio indication, a signal to noise plus interference ratio indication, a received error vector magnitude indication, and a received power and received phase indication.

19. The method of claim 14, further comprising the step of determining, by the first transmitting device, transmission characteristics based at least in part on the received transmission information, and the first signal is transmitted based on the transmission characteristics.

20. The method of claim 19, wherein the transmission characteristics comprise one or more of the following: a power parameter, a phase rotation parameter, a phase equalization parameter, and an amplitude equalization parameter.
